(19) United States
(12) Patent Application Publication
(10) Pub. No.: US 2016/0180143 A1
(43) Pub. Date: Jun. 23, 2016

(54) EYE TRACKING WITH 3D EYE POSITION ESTIMATIONS AND PSF MODELS

(71) Applicant: Intel Corporation, Santa Clara, CA (US)

(72) Inventor: Nizan Horesh, Caesarea (IL)

(21) Appl. No.: 14/574,148

(22) Filed: Dec. 17, 2014

(51) Int. Cl. G06K 9/00; G06K 9/52; H04N 13/00

(52) U.S. Cl. CPC G06K 9/0061; H04N 13/00; G06K 9/00604; G06K 9/52

(57) ABSTRACT

Apparatuses, methods and storage medium associated with computing that includes eye tracking. In embodiments, an apparatus may include an image capturing device, and a plurality of PSF models of the image capturing device for a plurality of 3D eye positions. The apparatus may also include an eye tracking engine to receive an image, and analyze the image to generating gaze data for an eye in the image. The generation of gaze data may include employment of one or more of the PSF models selected based on one or more estimations of the 3D eye position of the eye in the image. Other embodiments may be described and/or claimed.

### TECHNICAL FIELD

The present disclosure relates to the field of data processing. More particularly, the present disclosure relates to eye tracking method and apparatus that includes the use of three dimensional (3D) eye position estimations and Point-Spread-Function (PSF) Models.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Remote eye tracking system typically captures images of the eyes using dedicated illumination (e.g., infra-red). The captured images are then analyzed to find the pupil contour and the conical reflections (commonly referred to as glints) of the light sources. Using the location of the glints and the knowledge of the camera and light properties as well as the radius of curvature of the cornea, the eye tracker computes the 3D position of the eye (i.e., the cornea center of curvature) based on optical geometry. Thus, an accurate location of the glint is essential for accurate gaze estimation.

In prior art setups, the glints typically have a size of 1-5 pixels (depending on the distance from the camera). In order to achieve good gaze estimation accuracy (e.g. 0.5°), the location of the glints need to be estimated within accuracy of 0.2 pixels, in order to obtain accurate eye tracking.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a computing arrangement with eye tracking, according to various embodiments.

FIG. 2 illustrates the eye tracker of FIG. 1 in further details, according to various embodiments

FIG. 3 illustrates an example process for generating gaze data, according to the various embodiments,

FIG. 4 illustrates a number of pictorial representations of example PSF Models, according to the various embodiments.

FIG. 5 illustrates an example computing system suitable for use to practice aspect of the present disclosure, according to various embodiments.

FIG. 6 illustrates a storage medium having instructions for practicing methods described with references to FIGS. 1-4, according to disclosed embodiments.

### DETAILED DESCRIPTION

Apparatuses, methods and storage medium associated with computing that includes eye tracking In embodiments, an apparatus may include an image capturing device, and a plurality of PSF models of the image capturing device fir a plurality of 3D eye positions. The apparatus may also include an eye tracking engine to receive an image, and analyze the image to generate gaze data for an eye in the image. The generation of gaze data may include employment of one or more of the PSF models selected based on one or more estimations of the 3D eye position of the eye in the image.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

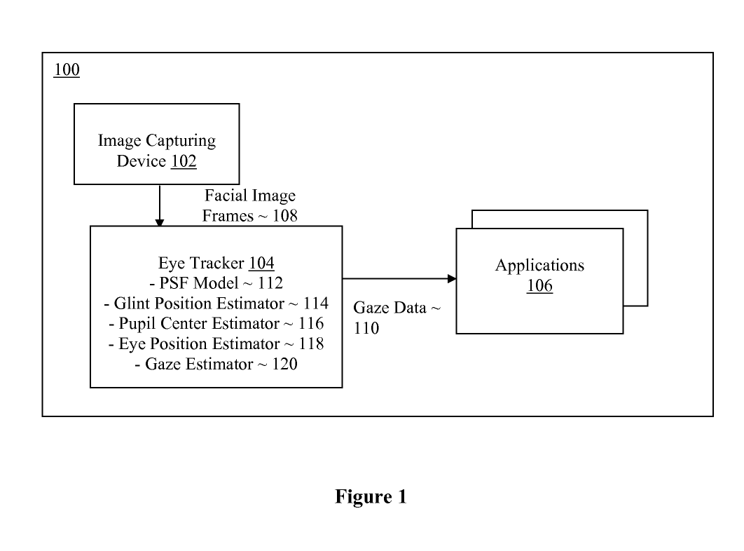

Referring now FIG. 1, wherein a computing arrangement with eye tracking, in accordance with various embodiments, is shown. As illustrated, computing arrangement 100 may include image capturing device 102, eye tracker 104 and applications 106, coupled with each other as shown. Image capturing device 102 may be configured to capture one or more facial image frames 108 of a user of computing arrangement 100 having the user's face, and provide the facial image frames 108 to eye tracker 104. Eye tracker 104 may be configured to analyze facial image frames 108 to generate gaze data 110 for use by e.g., applications 106. In embodiments, eye tracker 104, for efficiency of computation, generates gaze data 110 employing a number of PSF models of image capturing device 102 for various 3D tracking volume positions in estimating the glint positions of the eyes in facial image frames 108. The PSF models used are selected based at least in part on estimated 3D eye positions, which are estimated based at least in part on the estimated glint positions. That is, computationally, eye tracker 104 considers the light sources as a point-source, since the light sources are typically relatively small.

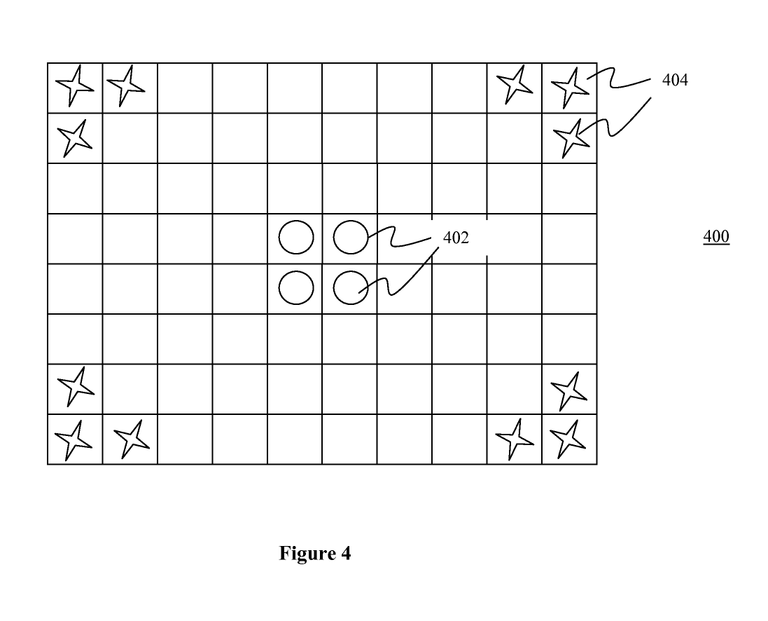

Selected ones of an array of example PSF models of image capturing device 102 for a number of 3D tracking volume positions are pictorially illustrated in FIG. 4, collectively denoted as 400. Each tracking volume position is a portion (volume) of the real 3D space (i.e. the world) that is of interest (to the eye tracker 104). In an ideal image capturing device, the PSF has a disk shape which grows linearly in distance from the focus plane. However, in real life, the shape of the PSF is subjected to all the optical aberrations and can change significantly from a disk. For example, the shape of the PSF changes from a circular shape 402 in the illustration at the center of the array of PSF shown in FIG. 4 to a rotated ‘X’-like shape 404 in the illustrations at the corners of the array of PSF shown in FIG. 4. Internally, within computing arrangement 100, the PSF models may be represented by matrices with values corresponding to the intensity of the pixels. The matrices may be stored in database disposed in a storage device (not shown) of computing arrangement 100. For computational efficiency, all or part of the database may also be pre-fetched and stored in cache memory (also not shown) of computing arrangement 100. Alternatively, the PSF models may be represented by mathematical formulas.

Still referring to FIG. 1, image capturing device 102 may be any one of a number of image capturing devices known in the art, including, but are not limited to, FL3-U3-32S2M-CS available from Point Grey of Canada. In embodiments, eye tracker 104 may include the earlier described PSF models 112, glint position estimator 114, pupil center estimator 116, eye position estimator 118 and gaze estimator 120, coupled with each other, to cooperate to analyze image frames 108 and generate gaze data 110 for applications 106. Applications 106 may be any one of a number of applications that can use gaze data 110, including, but are not limited to, games, readers, e-commerce applications, and so forth.

In embodiments, image capturing device 102, eye tracker 104 and applications 106 may all be disposed on the same device. In other words, computing arrangement 100 may be a single device, such as, but not limited to, a wearable device, a camera, a smartphone, computing tablet, an e-reader, ultrabook, a laptop computer, a desktop computer, a game console, a set-top box, and so forth. In other embodiments, image capturing device 102, eye tracker 104, applications 106, or combinations thereof may be disposed in different devices. For example, in one instance, image capturing device 102 may be disposed in a peripheral device, eye tracker 104 may be disposed on a local computing device proximately disposed to the peripheral device, and applications 106 may be disposed in a remote server, such as a cloud computing server. Other dispositions are possible.

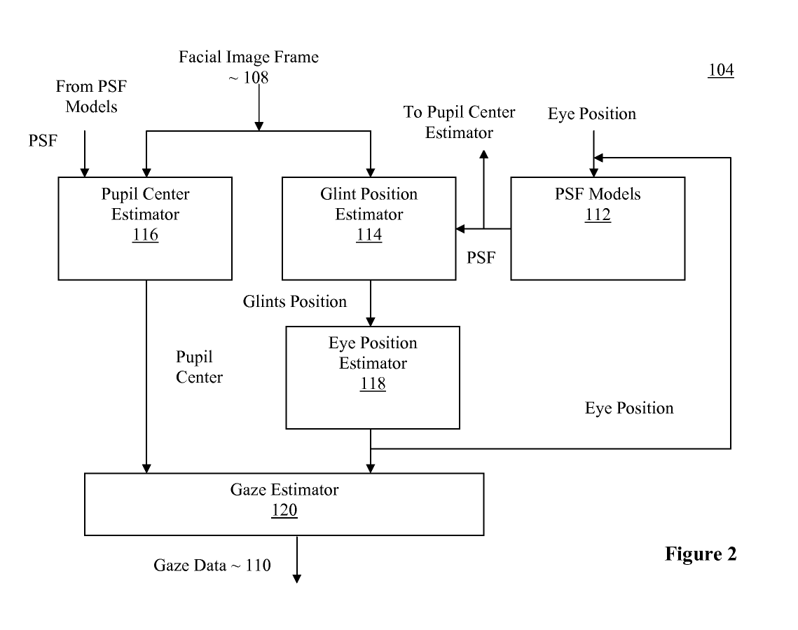

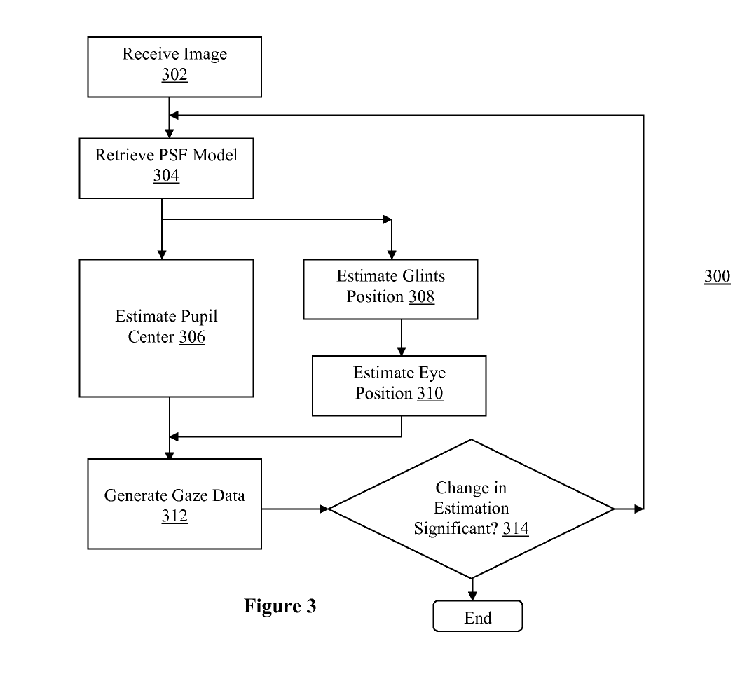

Referring now to FIG. 2, wherein the eye tracker of FIG. 1 is illustrated in further detail, in accordance with various embodiments. As shown and described earlier, eye tracker 104 may include PSF models 112, glint position estimator 114, pupil center estimator 116, eye position estimator 118 and gaze estimator 120, coupled with each other, to cooperate to analyze facial image frames 108 to generate gaze data 110. In embodiments, these elements 112-120 may be iteratively employed to estimate the glint position, the 3D eye position and the pupil center, and generate gaze data 110 based on the latest estimates of the glint position, the 3D eye position and the pupil center. The process may be repeated until the successive generations of gaze data 110 converge. In practice, the process may be repeated until successive estimations of the 3D eye position differ only by a predetermined threshold. These elements will now be described in turn, and the process will be described later with references to FIG. 3.

PSF Models: Each PSF model 112, as described earlier, may provide the PSF shape for a 3D tracking volume position. In embodiments, the PSF models may be represented by matrices with values corresponding to the intensity of the pixels. The matrices may be stored in a database. Given a 3D eye position, the database may return the PSF suitable for the 3D eye position. Other embodiments may create a mathematical model of the PSF as function of the 3D eye position and compute or interpolate therefrom when needed.

Glint Position Estimator: As shown, glint position estimator 114 may be configured to receive facial image frames 108, analyze facial image frames 108, detect the glints and then estimate their positions. A glint's sub-pixel position may be estimated by correlating a facial image frame 108 with a PSF (selected based on a current estimate of the 3D position of the eye in facial image frame 108), identifying the peaks of the correlation function and then interpolating the peaks for sub-pixel accuracy. Other implementations may include minimizing the following function:

Σ_{x,y}|I(x,y)−αPSF(x+δx,y+δy)|
subjected to α, δx and δy;
where I(x,y) is the intensity at location (x,y),
α is the intensity gain factor,
δx, the displacement of x, and
δy, the displacement of y.

The displacements of x and y refer to the x and y differences between the glint position estimated for facial image frame 108 and the PST being applied.

In embodiments, at the initial round of estimation, prior to eye position estimator 118 having made an estimation of the 3D eye position, glint position estimator 114 may be configured to estimate the glint position without using a PSF model, or use a PSF model selected based on an assumed (default) 3D eye position.

Pupil Center Estimator: As shown, pupil center estimator 116 may be configured to receive facial image frame 108, analyzes facial image frame 100, detect the pupil region and estimate the pupil center. The estimation may be performed in accordance with any one of a number of techniques known in the art, e.g., the techniques disclosed by Ohno T. et al, described in Ohno, T., Mukawa, N., Yoshikawa, A.: FreeGaze: A Gaze Tracking System for Everyday Gaze Interaction, Proc. of ETRA2002, 125-132. In embodiments, the PSF information may be applied in a deconvolution process. The deconvolution process may eliminate the distortion caused by the PSF. Further, the deconvolution process may be any one of a number of deconvolution process known in the art, e.g. the Lucy-Richardson algorithm. See Richardson, William Hadley (1972). “Bayesian-Based Iterative Method of Image Restoration”. JOSA 62(1): 55-59, and Lucy, L. B. (1974). “An iterative technique for the rectification of observed distributions”. Astronomical Journal 79(6): 745-754, for further detail.

In embodiments, at the initial round of estimation, prior to eye position estimator 118 having made an estimation of the 3D eye position, similar to glint position estimator 114, pupil center estimator 116 may be configured to estimate the pupil center without using a PSF model, or use a PSF model selected based on an assumed (default) 3D eye position.

Eye Position Estimator: As shown, the eye position estimator 118 may be configured to use the glint position estimated by glint position estimator 114, and the a-priori knowledge of the properties and location of image capturing device 102, the light source location and the human subject cornea's radius of curvature, to solve the optical geometry and get the 3D cornea center of curvature. Similarly, these operations may be performed in accordance with any one of a number of techniques known in the art, e.g., the techniques described in the earlier mentioned Ohno et al article.

Gaze Estimator: As shown, gaze estimator 120 may be configured to use the pupil center estimated by pupil center estimator 116, and the 3D eye position estimated by eye position estimator 108 to generate gaze data 110. In embodiments, gaze data 110 may depict a gaze point in the form of a gaze vector. In embodiments, the gaze vector may be a gaze direction vector (3D unit vector) and the gaze vector origin (a 3d point) that allows the computation of the gaze point on a given surface by intersecting the gaze direction with the surface. Additionally, the gaze data may include associate probably distribution (to represent the uncertainty of the values). Similarly, these operations may be performed in accordance with any one of a number of techniques known in the art, e.g., the techniques described in the earlier mentioned Ohno et al article.

In embodiments, glint position estimator 114, pupil center estimator 116, eye position estimator 118 and gaze estimator 120 may be implemented in hardware, software or combination thereof. Examples of hardware implementation may include Application Specific Integrated Circuits (ASIC), or field programmable circuits programmed with the logics to perform the operations described herein. Examples of software implementations may include implementations in high level languages compilable into execution code for various targeted processors.

Referring now to FIG. 3, wherein an example process for generating gaze data, in accordance with embodiments, is shown. As shown, process 300 for generating gaze data may include operations performed in blocks 302-314. In embodiments, the operations may be performed by earlier described glint position estimator 114, pupil center estimator 116, eye position estimator 118 and/or gaze estimator 120. In alternate embodiments, the operations may be performed by more or less components, or in different order.

As shown, process 300 may begin at block 302. At block 302, a facial image frame may be received. Next, at block 304, a PSF model may be retrieved. In embodiments, the PSF model may be retrieved based on an assumed, e.g., default 3D eye position of an eye in the received facial image frame. In other embodiments, operations at block 304 may be skipped for the first iteration of process 300. From block 304, process 300 may proceed in parallel to blocks 306 and 308.

At block 306, the pupil center of an eye in the received facial image frame may be estimated, applying the PSF model retrieved at block 304, as earlier described. In embodiments, the pupil center of an eye in the received facial image frame may be estimated, without applying a PSF model, during the first/initial iteration of the process, for embodiments where block 304 is skipped.

At block 308, the glint position of an eye in the received facial image frame may be estimated, applying the PSF model retrieved at block 304, as earlier described. In embodiments, the glint position of an eye in the received facial image frame may be estimated, without applying a PSF model, during the first/initial iteration of the process, for embodiments where block 304 is skipped. Next after block 308, at block 310, the 3D eye position of the eye in the received facial image frame may be estimated, based at least in part on the current estimation of the glint position of the eye, as earlier described.

After blocks 306 and 310, process 300 may proceed to block 312. At block 312, the gaze data, e.g., a gaze point in the form of a gaze vector, may be generated, based at least in part on the estimated pupil center position and the estimated 3D eye position.

Next at block 314, a determination may be made whether the generated gaze data is significantly different from the generated data of a prior iteration of process 300. In embodiments, the determination may be made based at least in part on whether successive estimations of the 3D eye position differ in excess of a pre-determined threshold. In embodiments, the size of the pre-determined threshold may be empirically selected based on the level of accuracy required for the gaze data.

If a result of the determination at block 314 indicates the gaze data has changed significantly, process 300 may return to block 304, and repeat the process again, using the new estimation of the 3D eye position. However, if a result of the determination at block 314 indicates the gaze data has not changed significantly, process 300 may end, and the gaze data may be outputted.

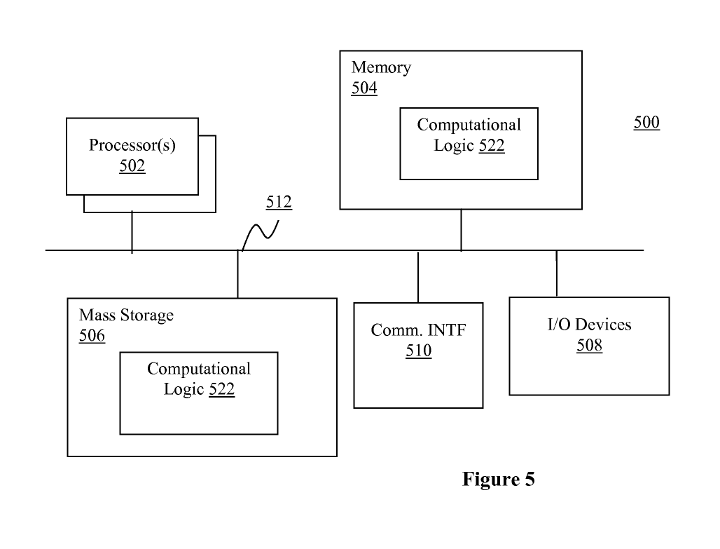

Referring now to FIG. 5, wherein an example computer system suitable for practicing aspect of the present disclosure, according to various embodiments, is shown. As illustrated, computer system 500 may include one or more processors 502 and system memory 504. Each processor 502 may include one or more processor cores. System memory 504 may include non-persistent copies of the operating system and various applications, including in particular, eye tracker 104 of FIG. 1, collectively denoted as computational logic 522. Additionally, computer system 500 may include one or more mass storage devices 506, input/output devices 508, and communication interfaces 510. The elements 502-510 may be coupled to each other via system bus 512, which may represent one or more buses. In the case of multiple buses, they may be bridged by one or more bus bridges (not shown).

Mass storage devices 506 may include persistent copies of computational logic 522. Examples of mass storage devices 506 may include, but are not limited to, diskettes, hard drives, compact disc read only memory (CD-ROM) and so forth. Examples of communication interfaces 510 may include, but are not limited to, wired and/or wireless network interface cards, modems and so forth. Communication interfaces 510 may support a variety of wired or wireless communications including, but are not limited, 3G/4G/5G, WiFi, Bluetooth®, Ethernet, and so forth. Examples of input/output devices 508 may include keyboard, cursor control, touch-sensitive displays, image capturing device 102, and so forth.

Except for eye tracker 104, each of these elements 502-512 may perform its conventional functions known in the art. The number, capability and/or capacity of these elements 502-512 may vary, depending on whether computer system 500 is used as a client device or a server. When use as client device, the capability and/or capacity of these elements 502-512 may vary, depending on whether the client device is a stationary device, like a desktop computer, a game console or a set-top box, or a mobile device, like a wearable device, a camera, a smartphone, a computing tablet, an ultrabook or a laptop. Otherwise, the constitutions of elements 502-512 are known, and accordingly will not be further described.

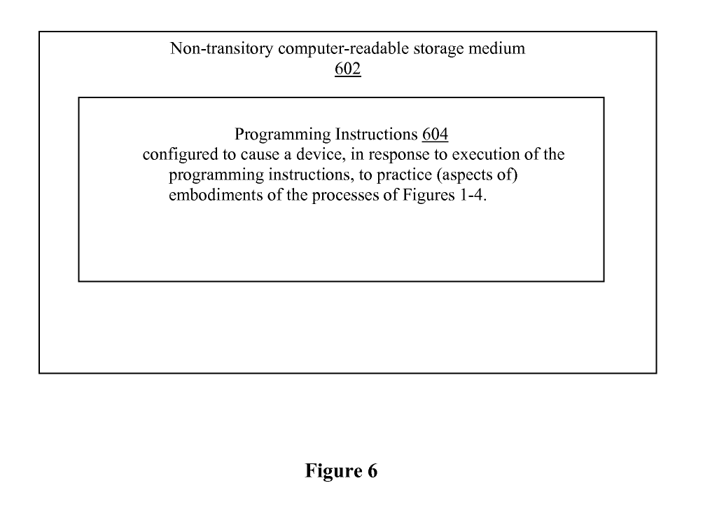

As will be appreciated by one skilled in the art, the present disclosure may be embodied as methods or computer program products. Accordingly, the present disclosure, in addition to being embodied in hardware as earlier described, may take the form of an entirety software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., computer system 300, in response to execution of the programming instructions, to perform, e.g., various operations associated with eye tracker 104. In alternate embodiments, programming instructions 604 may be disposed on multiple computer-readable non-transitory storage media 602 instead. In alternate embodiments, programming instructions 604 may be disposed on computer-readable transitory storage media 602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functionslacts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 5, for one embodiment, at least one of processors 502 may be packaged together with memory having eye tracker 104. For one embodiment, at least one of processors 502 may be packaged together with memory having eye tracker 104 to form a System in Package (SiP). For one embodiment, at least one of processors 502 may be integrated on the same die with memory having eye tracker 104. For one embodiment, at least one of processors 502 may be packaged together with memory having eye tracker 104 to form a System on Chip (SoC). For at least one embodiment, the SoC may be utilized in, e.g., but not limited to, a wearable device, a smartphone or computing tablet.

Thus various example embodiments of the present disclosure have been described including, but are not limited to:

Example 1 may be an apparatus for computing with eye tracking. The apparatus may comprise an image capturing device; a plurality of Point-Spread-Function, PSF, models of the image capturing device for a plurality of three dimensional, 3D, tracking volume positions, and an eye tracking engine. The eye tracking engine may be configured to receive an image, and analyze the image to generate gaze data for an eye in the image. The generation of gaze data may include employment of one or more of the PSF models selected based on one or more estimations of the 3D eye position of the eye in the image.

Example 2 may be example 1, wherein the eye tracking engine may include a pupil center estimator to estimate a pupil center position of the eye in the image.

Example 3 may be example 1 or 2, wherein the eye tracking engine may include a glint position estimator to be iteratively employed to estimate a glint position of the eye in the image.

Example 4 may be example 3, wherein the glint position estimator may be configured to employ one of the PSF models selected based on a prior estimate of a 3D eye position of the eye in the image to estimate the glint position of the eye in the image, starting at least at a second iteration of the iterative estimate of the glint position, after an initial estimation of the glint position.

Example 5 may be example 4, wherein the glint position estimator may be configured to make the initial estimation of the glint position without employing one of the PSF models.

Example 6 may be example 4, wherein the glint position estimator may be configured to make the initial estimation of the glint position employing one of the PSF models selected based on an initial estimation of the 3D eye position of to the eye in the image.

Example 7 may be any one of examples 3-6, wherein the eye tracking engine may include an eye position estimator to be iteratively employed in conjunction with the glint position estimator to iteratively estimate the 3D position of the eye in the image.

Example 8 may be example 7, wherein the eye position estimator may be configured to be iteratively employed in conjunction with the glint position estimator to iteratively estimate the 3D position of the eye in the image, until successive estimations of the 3D position of the eye differ less than a threshold.

Example 9 may be any one of examples 1-8, wherein the eye tracking engine may include a gaze estimator to estimate a gaze point, based at least in part on an estimated pupil center position of the eye in the image, and an estimated 3D eye position of the eye in the image.

Example 10 may be example 9, wherein the apparatus may be a selected one of a wearable device, a camera, a smartphone, a computing tablet, an e-reader, an ultrabook, a laptop computer, a desktop computer, a game console, or a set-top box.

Example 11 may be a method for computing with eye tracking. The method may comprise receiving, by a computing device, an image captured by an image capturing device; and analyzing the image, by the computing device, including generating gaze data for an eye in the image. Further, generating gaze data may include employing one or more of a plurality of Point-Spread-Function, PSF, models of the image capturing device for a plurality of three dimensional, 3D, tracking volume positions, the one or more PSF models being selected based on one or more estimations of an eye position of the eye in the image.

Example 12 may be example wherein analyzing comprises estimating a pupil center position of the eye in the image.

Example 13 may be example 11 or 12, wherein analyzing may comprise iteratively estimating a glint position of the eye in the image.

Example 14 may be example 13, wherein iteratively estimating may include employing one of the PSF models selected based on a prior estimate of a 3D eye position of the eye in the image in estimating the glint position of the eye in the image, starting at least at a second iteration of the iterative estimating of the glint position, after an initial estimation the glint position.

Example 15 may be example 14, further comprising initially estimating the glint position without employing one of the PSF models.

Example 16 may be example 14 or 15, further comprising initially estimating the glint position employing one of the PSF models selected based on an initial estimation of the 3D eye position of to the eye in the image.

Example 17 may be any one of examples 13-16, wherein analyzing may comprise iteratively estimating the 3D position of the eye in the image, in conjunction with the iteratively estimation of the glint position.

Example 18 may be example 17, wherein analyzing may comprise iteratively estimating the 3D position of the eye in the image, in conjunction with the iterative estimation of the glint position, until successive estimations of the 3D position of the eye differ less than a threshold.

Example 19 may be any one of examples 11-18, wherein generating gaze data may comprise estimating a gaze point, based at least in part on an estimated pupil center position of the eye in the image, and an estimated 3D eye position of the eye in the image.

Example 20 may be example 19, wherein estimating the gaze point may comprise generating a gaze vector.

Example 21 may be one more computer-readable medium having stored therein a plurality of instructions to cause a computing device, in response to execution of the instructions by the computing device, to provide the computing device with an eye tracking engine to: receive an image captured by an image capturing device; and analyze the image, including generation of gaze data for an eye in the image. Further, generation of gaze data may include employment of one or more of a plurality of Point-Spread-Function, PSF, models of the image capturing device for a plurality of three dimensional, 3D, tracking volume positions, the one or more PSF models being selected based on one or more estimations of an eye position of the eye in the image.

Example 22 may be example 21, wherein the eye tracking engine may comprise a pupil center estimator to estimate a pupil center position of the eye in the image.

Example 23 may be example 21 or 22, wherein the eye tracking engine may comprise a glint position estimator to be iteratively employed to estimate a glint position of the eye in the image.

Example 24 may be example 23, wherein the glint position estimator may be configured to employ one of the PSF models selected based on a prior estimate of a 3D eye position of the eye in the image to estimate the glint position of the eye in the image, starting at least at a second iteration of the iterative estimate of the glint position, after an initial estimation of the glint position.

Example 25 may be example 24, wherein the glint position estimator may be configured to make the initial estimation of the glint position without employing one of the PSF models.

Example 26 may be example 24 or 25, wherein the glint position estimator may be configured to make the initial estimation of the glint position employing one of the PSF models selected based on an initial estimation of the 3D eye position of to the eye in the image.

Example 27 may be any one of examples 23-26, wherein the eye tracking engine may comprise an eye position estimator to be iteratively employed in conjunction with the glint position estimator to iteratively estimate the 3D position of the eye in the image.

Example 28 may be example 27, wherein the eye position estimator is to be iteratively employed in conjunction with the glint position estimator to iteratively estimate the 3D position of the eye in the image, until successive estimations of the 3D position of the eye differ less than a threshold.

Example 29 may be any one of examples 21-28, wherein the eye tracking engine may comprise a gaze estimator to estimate a gaze point, based at least in part on an estimated pupil center position of the eye in the image, and an estimated 3D eye position of the eye in the image.

Example 30 may be example 29, wherein the computing device may be a selected one of a wearable device, a camera, a smartphone, a computing tablet, an e-reader, an ultrabook, a laptop computer, a desktop computer, a game console, or a set-top box.

Example 31 may be an apparatus for computing, comprising: means for receiving, an image captured by an image capturing device; and means for analyzing the image, including means for generating gaze data for an eye in the image. Further, the means for generating gaze data may include means for employing one or more of a plurality of Point-Spread-Function, PSF, models of the image capturing device for a plurality of three dimensional, 3D, tracking volume positions, the one of more PSF models being selected based on one or more estimations of an eye position of the eye in the image.

Example 32 may be example 31, wherein means for analyzing may comprise means for estimating a pupil center position of the eye in the image.

Example 33 may be example 31 or 32, wherein means for analyzing may comprise means for iteratively estimating a glint position of the eye in the image.

Example 34 may be example 33, wherein means for iteratively estimating may include means for employing one of the PSF models selected based on a prior estimate of a 3D eye position of the eye in the image in estimating the glint position of the eye in the image, starting at least at a second iteration of the iterative estimating of the glint position, after an initial estimation the glint position.

Example 35 may be example 34, further comprising means for initially estimating the glint position without employing one of the PSF models.

Example 36 may be example 34, further comprising means for initially estimating the glint position employing one of the PSF models selected based on an initial estimation of the 3D eye position of to the eye in the image.

Example 37 may be any one of examples 33-36, wherein means for analyzing comprises means for iteratively estimating the 3D position of the eye in the image, in conjunction with the iteratively estimation of the glint position.

Example 38 may be example 37, wherein means for analyzing may comprises iteratively estimating the 3D position of the eye in the image, in conjunction with the iterative estimation of the glint position, until successive estimations of the 3D position of the eye differ less than a threshold.

Example 39 may be any one of examples 31-38, wherein means for generating gaze data may comprise means for estimating a gaze point, based at least in part on an estimated pupil center position of the eye in the image, and an estimated 3D eye position of the eye in the image.

Example 40 may be example 39, wherein means for estimating the gaze point comprises means for generating a gaze vector.

Example 41 may be example 4, wherein the glint position estimator is to estimate the glint position of the eye in the image, by computing:

Σ_{x,y}|I(x,y)−αPSF(x+δx,y+δy)|
subjected to α, δx, and δy;
where I(x,y) is the intensity at location (x,y),
α is the intensity gain factor,
α the displacement of x, and
δy, the displacement of y.

Example 42 may be example 14, wherein estimating the glint position of the eye in the image comprises computing:

Σ_{x,y}|I(x,y)−αPSF(x+δx,y+δy)|
subjected to α, δx, and δy;
where I(x,y) is the intensity at location (x,y),
α is the intensity gain factor,
δx, the displacement of x, and
δy, the displacement of y.

Example 43 may be example 24, wherein the glint position estimator is to estimate the glint position of the eye in the image, by computing:

Σ_{x,y}|I(x,y)−αPSF(x+δx,y+δy)|
subjected to α, δx, and δy;
where I(x,y) is the intensity at Location (x,y),
α is the intensity gain factor,
δx, the displacement of x, and
δy, the displacement of y.

Example 44 may be example 34, wherein means for employing one of the PSF models selected based on a prior estimate of a 3D eye position of the eye in the image in estimating the glint position of the eye in the image comprises means for computing:

Σ_{x,y}|I(x,y)−αPSF(x+δx,y+δy)|
subjected to α, δx, and δy;
where I(x,y) is the intensity at location (x,y),
α is the intensity gain factor,
δx, the displacement of x, and
δy, the displacement of y.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus for computing with eye tracking, comprising:
an image capturing device;
a plurality of Point-Spread-Function, PSF, models of the image capturing device for a plurality of three dimensional, 3D, tracking volume positions; and
an eye tracking engine to receive an image, and analyze the image to generate gaze data for an eye in the image, wherein generation of gaze data includes employment of one or more of the PSF models selected based on one or more estimations of the 3D eye position of the eye in the image.

2. The apparatus of claim 1, wherein the eye tracking engine comprises a pupil center estimator to estimate a pupil center position of the eye in the image.

3. The apparatus of claim 1, wherein the eye tracking engine comprises a glint position estimator to be iteratively employed to estimate a glint position of the eye in the image.

4. The apparatus of claim 3, wherein the glint position estimator is to employ one of the PSF models selected based on a prior estimate of a 3D eye position of the eye in the image to estimate the glint position of the eye in the image, starting at least at a second iteration of the iterative estimate of the glint position, after an initial estimation of the glint position.

5. The apparatus of claim 4, wherein the glint position estimator is to make the initial estimation of the glint position without employing one of the PSF models.

6. The apparatus of claim 4, wherein the glint position estimator is to make the initial estimation of the glint position employing one of the PSF models selected based on an initial estimation of the 3D eye position of to the eye in the image.

7. The apparatus of claim 3, wherein the eye tracking engine comprises an eye position estimator to be iteratively employed in conjunction with the glint position estimator to iterative estimate the 3D position of the eye in the image.

8. The apparatus of claim 7, wherein the eye position estimator is to be iteratively employed in conjunction with the glint position estimator to iteratively estimate the 3D position of the eye in the image, until successive estimations of the 3D position of the eye differ less than a threshold.

9. The apparatus of claim 1, wherein the eye tracking engine comprises a gaze estimator to estimate a gaze point, based at least in part on an estimated pupil center position of the eye in the image, and an estimated 3D eye position of the eye in the image.

10. The apparatus of claim 9, wherein the apparatus is a selected one of a wearable device, a camera, a smartphone, a computing tablet, an e-reader, an ultrabook, a laptop computer, a desktop computer, a game console, or a set-top box.

11. A method for computing with eye tracking, comprising:
receiving, by a computing device, an image captured by an image capturing device; and
analyzing the image, by the computing device, including generating gaze data for an eye in the image;
wherein generating gaze data includes employing one or more of a plurality of Point-Spread-Function, PSF, models of the image capturing device for a plurality of three dimensional, 3D, tracking volume positions, the one or more PSF models being selected based on one or more estimations of an eye position of the eye in the image.

12. The method of claim 11, wherein analyzing comprises estimating a pupil center position of the eye in the image.

13. The method of claim 11, wherein analyzing comprises iteratively estimating a glint position of the eye in the image.

14. The method of claim 13, wherein iteratively estimating includes employing one of the PSF models selected based on a prior estimate of a 3D eye position of the eye in the image in estimating the glint position of the eye in the image, starting at least at a second iteration of the iterative estimating of the glint position, after an initial estimation the glint position.

15. The method of claim 13, wherein analyzing comprises iteratively estimating the 3D position of the eye in the image, in conjunction with the iterative estimation of the glint position, until successive estimations of the 3D position of the eye differ less than a threshold.

16. The method of claim 11, wherein generating gaze data comprises estimating a gaze point, based at least in part on an estimated pupil center position of the eye in the image, and an estimated 3D eye position of the eye in the image; wherein estimating the gaze point comprises generating a gaze vector.

17. One more computer-readable medium having stored therein a plurality of instructions to cause a computing device, in response to execution of the instructions by the computing device, to provide the computing device with an eye tracking engine to:
receive an image captured by an image capturing device; and
analyze the image, including generation of gaze data for an eye in the image;
wherein generation of gaze data includes employment of one or more of a plurality of Point-Spread-Function, PSF, models of the image capturing device for a plurality of three dimensional, 3D, tracking volume positions, the one or more PSF models being selected based on one or more estimations of an eye position of the eye in the image.

18. The computer-readable medium of claim 17, wherein the eye tracking engine comprises a pupil center estimator to estimate a pupil center position of the eye in the image.

19. The computer-readable medium of claim 17, wherein the eye tracking engine comprises a glint position estimator to be iteratively employed to estimate a glint position of the eye in the image.

20. The computer-readable medium of claim 19, wherein the glint position estimator is to employ one of the PSF models selected based on a prior estimate of a 3D eye position of the eye in the image to estimate the glint position of the eye in the image, starting at least at a second iteration of the iterative estimate of the glint position, after an initial estimation of the glint position.

21. The computer-readable medium of claim 20, wherein the glint position estimator is to make the initial estimation of the glint position without employing one of the PSF models.

22. The computer-readable medium of claim 20, wherein the glint position estimator is to make the initial estimation of the glint position employing one of the PSF models selected based on an initial estimation of the 3D eye position of to the eye in the image.

23. The computer-readable medium of claim 19, wherein the eye tracking engine comprises an eye position estimator to be iteratively employed in conjunction with the glint position estimator to iteratively estimate the 3D position of the eye in the image.

24. The computer-readable medium of claim 23, wherein the eye position estimator is to be iteratively employed in conjunction with the glint position estimator to iteratively estimate the 3D position of the eye in the image, until successive estimations of the 3D position of the eye differ less than a threshold.

25. The computer-readable medium of claim 17, wherein the eye tracking engine comprises a gaze estimator to estimate a gaze point, based at least in part on an estimated pupil center position of the eye in the image, and an estimated 3D eye position of the eye in the image.
